(19) United States
(12) Patent Application Publication
(10) Pub. No.: US 2012/0212766 A1
(43) Pub. Date: Aug. 23, 2012

(54) PRINT PROCESSING APPARATUS AND METHOD FOR CONTROLLING THE SAME

(75) Inventor: Yoshiharu Imamoto, Tokyo (JP)

(73) Assignee: CANON KABUSHIKI KAISHA, Tokyo (JP)

(21) Appl. No.: 13/399,972

(22) Filed: Feb. 17, 2012

(30) Foreign Application Priority Data
Feb. 22, 2011 (JP) 2011-036022
Jan. 25, 2012 (JP) 2012-013038

(51) Int. Cl. G06K 15/02; G06F 3/12

(52) U.S. Cl. 358/1.14; 358/1.15

(57) ABSTRACT

A print processing apparatus includes a plurality of processing units configured to deal with a plurality of printing processes, a storing unit configured to store a table in which processing start conditions in the plurality of printing processes are defined based on a distance between a user and the print processing apparatus, an acquisition unit configured to acquire a distance between a position of the user who has issued a print job and the print processing apparatus, and a control unit configured to control the plurality of processing units for the print job based on the table and the acquired distance.

### BACKGROUND OF THE INVENTION

1. Field of the Invention

The present invention relates to a technology for executing printing and outputting via a network.

2. Description of the Related Art

There has conventionally been known a technology for issuing a print job to a print processing apparatus connected to a network from a client apparatus, such as a computer or a smartphone, to output a printed product.

There is also known a technology for setting, rather than printing and outputting print jobs in an issued order, priorities on the print jobs conforming to set conditions to first print and output the print jobs high in priority. Japanese Patent Application Laid-Open No. 2006-227795 discusses a technology for giving high priority to a print job issued by a user close to the print processing apparatus.

However, in the technology discussed in Japanese Patent Application Laid-Open No. 2006-227795, the print jobs are sequentially printed and output in a high priority order. Consequently, printed products may be taken away before the user arrives at the print processing apparatus. On the other hand, in a case where print jobs are preprocessed to be stored in a storage area and are then printed after user authentication, a large storage area must be provided for storing the preprocessed data of print jobs, which are processed one after another.

### SUMMARY OF THE INVENTION

The present invention is directed to printing and outputting of print jobs issued via a network at user's arrival timing at a print processing apparatus.

According to an aspect of the present invention, a print processing apparatus includes a plurality of processing units configured to deal with a plurality of printing processes, a storing unit configured to store a table in which processing start conditions in the plurality of printing processes are defined based on a distance between a user and the print processing apparatus, an acquisition unit configured to acquire a distance between a position of the user who has issued a print job and the print processing apparatus, and a control unit configured to control the plurality of processing units for the print job based on the table and the acquired distance.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a functional block diagram illustrating a terminal apparatus and a print processing apparatus according to a first exemplary embodiment of the present invention.

FIG. 2 is a block diagram illustrating a print processing unit according to the first exemplary embodiment.

FIG. 3 is a flowchart illustrating an operation of the print processing apparatus according to the first exemplary embodiment.

FIGS. 4A, 4B, 4C, and 4D illustrate examples of tables and management information according to the first exemplary embodiment.

FIG. 5 is a flowchart illustrating an operation of a print processing apparatus according to a first modified example of the first exemplary embodiment.

FIG. 6 is a flowchart illustrating an operation of a print processing apparatus according to a second modified example of the first exemplary embodiment.

FIG. 7 is a functional block diagram illustrating a print processing apparatus according to a third modified example of the first exemplary embodiment.

FIG. 8 is a flowchart illustrating an operation of the print processing apparatus according to the third modified example.

FIG. 9 is a flowchart illustrating an operation of the terminal apparatus according to the first exemplary embodiment.

FIG. 10 is a functional block diagram illustrating a terminal apparatus, a print processing apparatus, and a management server according to a second exemplary embodiment of the present invention.

FIG. 11 is a flowchart illustrating an operation of the management server according to a second exemplary embodiment.

FIG. 12 is a flowchart illustrating an operation of the print processing apparatus according to the second exemplary embodiment.

### DESCRIPTION OF THE EMBODIMENTS

Various exemplary embodiments, features, and aspects of the invention will be described in detail below with reference to the drawings.

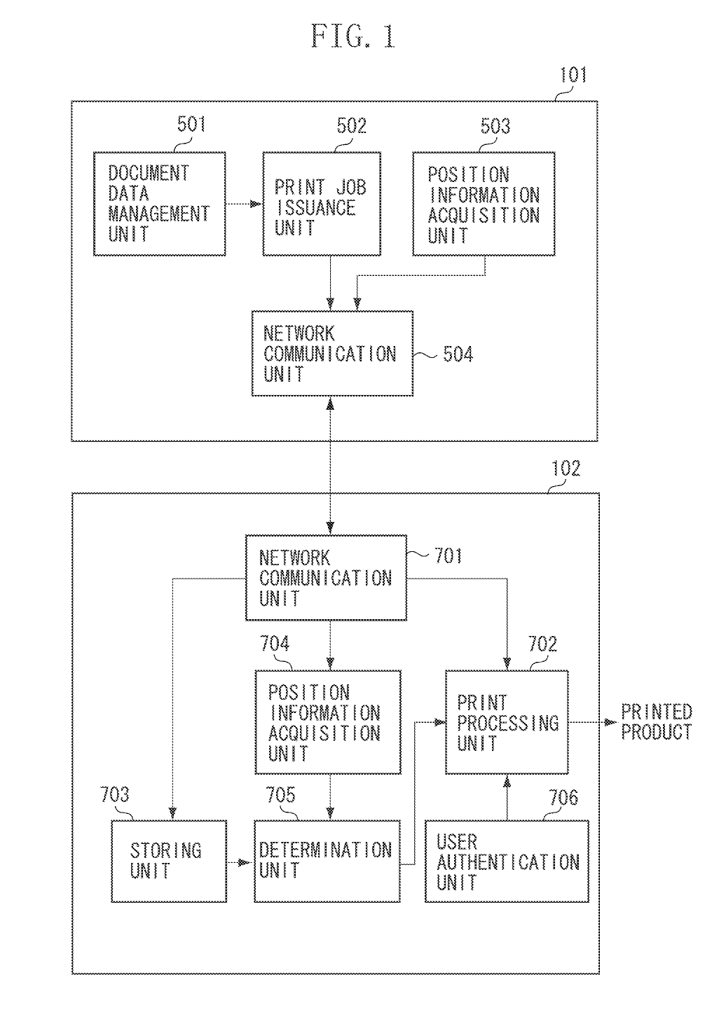

FIG. 1 illustrates an example of a system outline according to a first exemplary embodiment of the present invention. In FIG. 1, a terminal apparatus 101 and a print processing apparatus 102 transfer data via a network. FIG. 1 illustrates only one terminal apparatus. However, it is presumed that a plurality of terminal apparatuses is connected to the print processing apparatus via the network. Any combination of the units described below for each of the terminal apparatus 101 and the print processing apparatus 102 may, for example, be configured as an Application Specific Integrated Circuit (ASIC) or other device including a processor in the form of a central processing unit (CPU), a micro processing unit (MPU), and/or the like.

The terminal apparatus 101, when a user transmits a printing instruction to the print processing apparatus 102, is described.

A document data management unit 501 stores document data to be printed in the print processing apparatus 102. For example, when the document data is book data stored in the terminal apparatus 101, it is managed as data in a hard disk or a memory. When the document data is web content in the Internet, Hyper Text Markup Language (HTML) data or image data is managed by a web browser. Providing a function of displaying a preview image of the document data to a user enables the user to check a content of a print job to be issued.

A print job issuance unit 502 prepares the document data instructed to be printed by the user in a data format of a print job to transmit it to the print processing apparatus 102 via a network communication unit 504. When there is designation as to the number of printed products or imposition, the print job issuance unit 502 can add information designated by the user to the print job. In the first exemplary embodiment, the print job includes the document data designated by the user and user authentication information used for authenticating the user who has issued a printing request. The document data is text data, book data, image data, or a web page. The print job can further include property information such as a data size, the number of pages, or a data format of the document data, or print control information such as imposition or the number of prints of the document data. In the first exemplary embodiment, it is presumed that the document data, written in Extensible Markup Language (XML) Page Specification (XPS) format, is printed.

A position information acquisition unit 503 acquires position information of the user who has issued the print job. In the first exemplary embodiment, the position information acquisition unit 503 acquires position information of the terminal apparatus 101 presuming that the user has the terminal apparatus 101. As for an acquisition method, the position information can be acquired by a global positioning system (GPS) technology that uses an artificial satellite or a base station of a mobile phone, or by estimation based on an Internet Protocol (IP) address allocated to the terminal apparatus 101.

The network communication unit 504 transmits the print job or the position information to the print processing apparatus 102. For example, the network communication unit 504 controls communication processing of a wired local area network (LAN), a wireless LAN, or a portable wireless terminal to communicate data with the print processing apparatus 102.

A configuration of the print processing apparatus 102 that prints and outputs the print job issued by the user is described.

A network communication unit 701 acquires data from the terminal apparatus 101 via the network. The network communication unit 701 transmits data of the print job to be printed and output to a storing unit 703, the position information of the user who has issued the print job to a position information acquisition unit 704, and the document data included in the print job to a print processing unit 702. The network communication unit 701 controls communication processing of a wired local area network (LAN), a wireless LAN, or a portable wireless terminal to execute terminal apparatus data communication.

The storing unit 703 stores a table in which processing start conditions in a plurality of printing processes are defined based on a distance between the user and the print processing apparatus, management information indicating a processing status of the print job, and position information of the print processing apparatus 102.

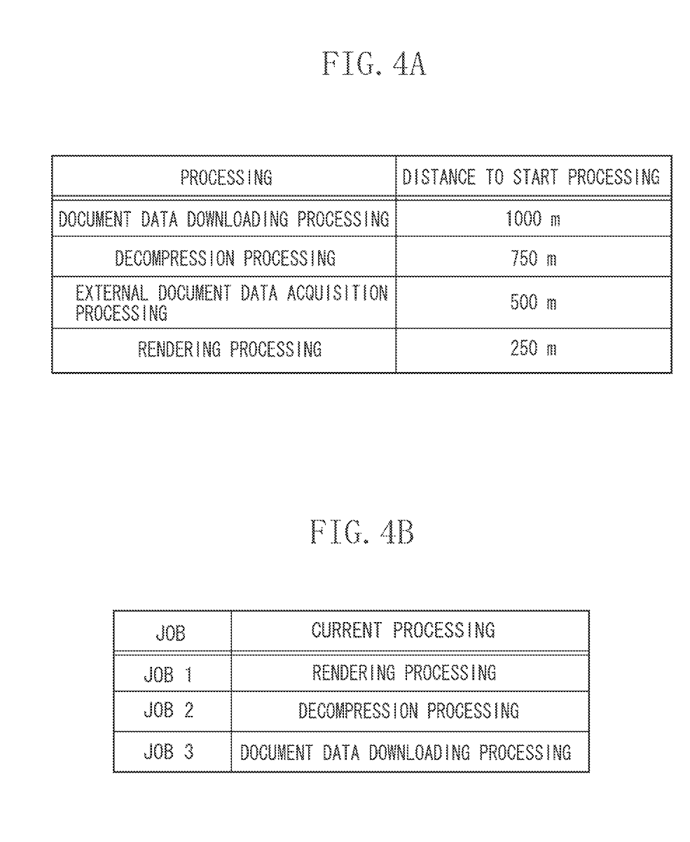

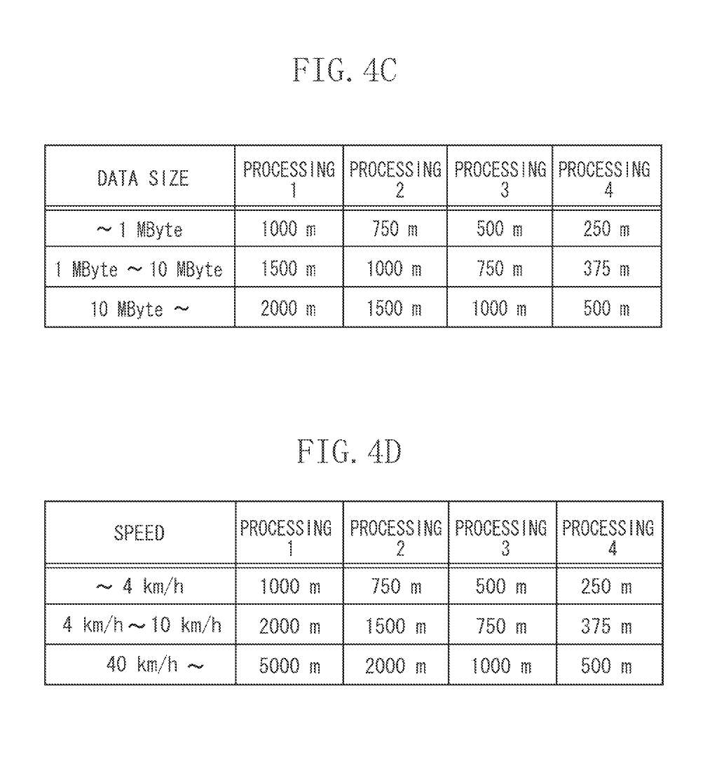

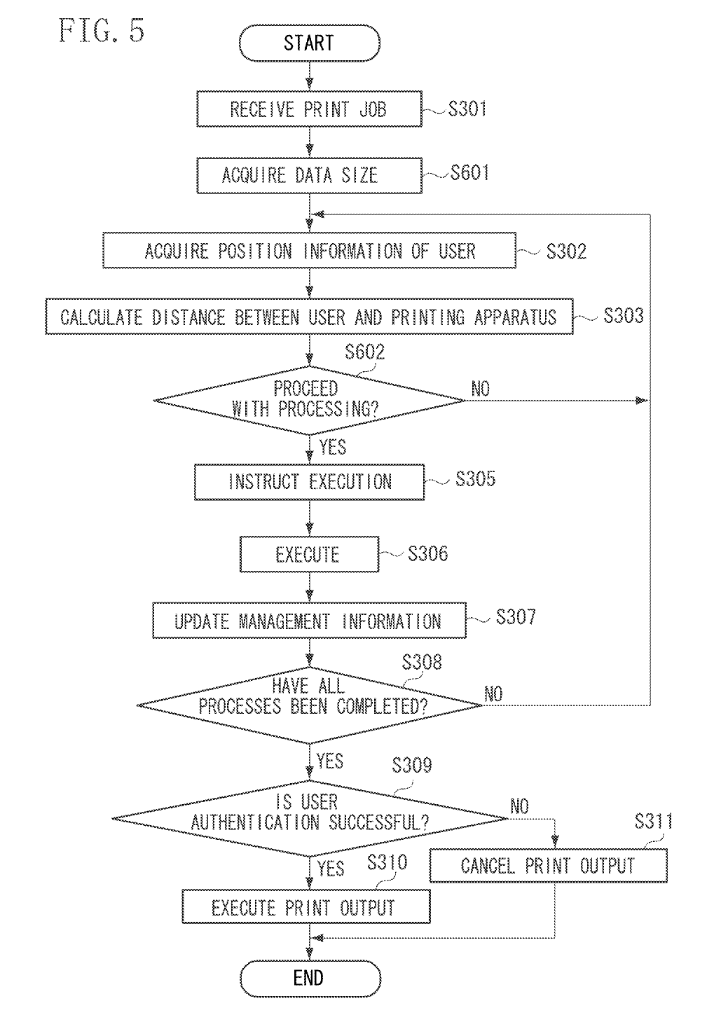

The table defines, for processes corresponding to the plurality of printing processes, conditions of starting the processes based on the distance between the user who has issued the print job and the print processing apparatus 102. FIG. 4A illustrates an example of the table. In the first exemplary embodiment, it is presumed that the printing processes are executed in the order of document data downloading processing, decompression processing, external document data acquisition processing, and rendering processing. The document data downloading processing, the decompression processing, the external document data acquisition processing, and the rendering processing are respectively started when distances between the user and the print processing apparatus become 1000 meters, 750 meters, 500 meters, and 250 meters, respectively. Long distances to start printing are allocated in the order of processes.

The table may be set beforehand during manufacturing or installation of the print processing apparatus 102. However, the table may alternatively be acquired from an external apparatus via the network. The printing processes are not limited to these. It is desired that values of distances to start printing be appropriately set based on an installing position of the print processing apparatus. For example, values of distances to start printing can be set small in the case of a print processing apparatus located in an urban area, and large in the case of a print processing apparatus located in a suburb.

The management information is for managing progresses of the processes corresponding to the plurality of printing processes. FIG. 4B illustrates an example of the management information. Current processes of a job 1, a job 2, and a job 3 are respectively rendering processing, decompression processing, and document data downloading processing. The management information is transmitted to a determination unit 705 described below to be used for determining a start of processing transition.

The position information of the print processing apparatus 102 is stored beforehand in the storing unit 703 during installation of the print processing apparatus 102. When the print processing apparatus 102 is not installed in a fixed place, the position information of the print processing apparatus 102 can be acquired to be stored at predetermined timing. As for an acquisition method, the position information can be acquired by the GPS technology, which uses an artificial satellite or a base station of a mobile phone, or by estimation based on an IP address allocated to the print processing apparatus 102. The position information acquisition unit 704 acquires the position information issued by the user from the network communication unit 701 to transmit it to the determination unit 705.

The determination unit 705 instructs, for the print job received from the storing unit 701, the print processing unit 702 to start processing based on a distance between the user who has issued the print job and the print processing apparatus 102 by using the table. Specifically, the determination unit 705 calculates a distance between the user and the print processing apparatus based on the position information of the user received from the position information acquisition unit 704 and the position information of the print processing apparatus 102. When processing having a small value of a distance to start the processing described in the table is not included in current processes contained in the management information, the print processing unit 702 is instructed to proceed with the processing.

A user authentication unit 706 authenticates a user who has issued the print job, and instructs the print processing unit 702 to start printing and outputting. In the first exemplary embodiment, the authentication unit 702 executes authentication based on user authentication information included in the print job and user authentication information input to the print processing apparatus 102. For an authentication method, for example, authentication can be executed based on a user identifier (ID) and a password, or possession of a smartphone, a mobile phone, or a device with an integrated circuit (IC) card. The print processing unit 702 executes a process of the print job through a plurality of processes necessary for printing and outputting the print job. When notified of success of the authentication of the user who has issued the print job from the user authentication unit 706, the print processing unit 702 starts printing and outputting of the print job issued by the user.

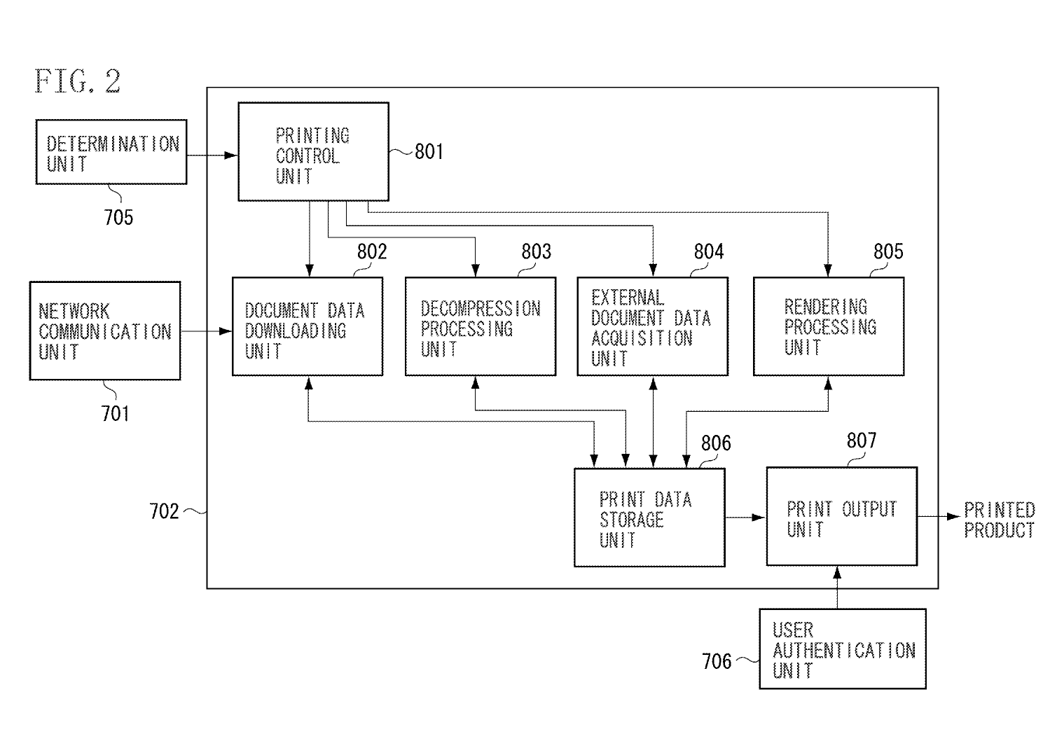

FIG. 2 illustrates a configuration of the print processing unit 702.

A printing control unit 801 starts processing defined for the print job in response to a printing instruction from the determination unit 705. The printing control unit 801 causes a document data downloading unit 802, a decompression processing unit 803, an external document data acquisition unit 804, and a rendering processing unit 805 in this order to process the print job. A storage capacity necessary for storing a processing result becomes larger each time the processing proceeds with the document data downloading unit 802, the decompression processing unit 803, the external document data acquisition unit 804, and the rendering processing unit 805 in this order.

The document data downloading unit 802 downloads document data of XPS format designated to be printed by the print job from an external apparatus via the network communication unit 701 to store it in a print data storage unit 806.

The decompression processing unit 803 decompresses the XPS data compressed by ZIP format, which has been stored in the print data storage unit 806 by the document data downloading unit 802, to store it in the print data storage unit 806.

The external document data acquisition unit 804 analyzes the decompressed document data stored in the print data storage unit 806 by the decompression processing unit 803 to acquire external document data necessary for printing. For example, by referring to an identifier such as Uniform Resource Locator (URL) described in the document data, the external document data acquisition unit 804 acquires image data of Joint Photographic Experts Group (JPEG) used as a part of the document data to store it in the print data storage unit 806.

The rendering processing unit 805 renders the document data decompressed by the decompression processing unit 803 and the external document data acquired by the external document data acquisition unit 804 to generate bitmap data of the document data, and stores it in the print data storage unit 806. The rendering is processing for converting document data described in Portable Document Format (PDF) or a page description language (PDL) such as PostScript into bitmap data.

The print data storage unit 806 records and stores the document data processed by the document data downloading unit 802, the decompression processing unit 803, the external document data acquisition unit 804, and the rendering processing unit 805. The print data storage unit 806 can be realized by a volatile memory such as a dynamic random access memory (DRAM) or a nonvolatile recording medium such as a hard disk. When the unit is realized by the volatile memory, apart of the stored data exceeding a capacity of the volatile memory can be swapped to a nonvolatile recording medium such as a hard disk drive.

A print output unit 807 prints and outputs, in response to a user authentication success notification from the user authentication unit 706, the bitmap data stored in the print data storage unit 806 to a paper medium.

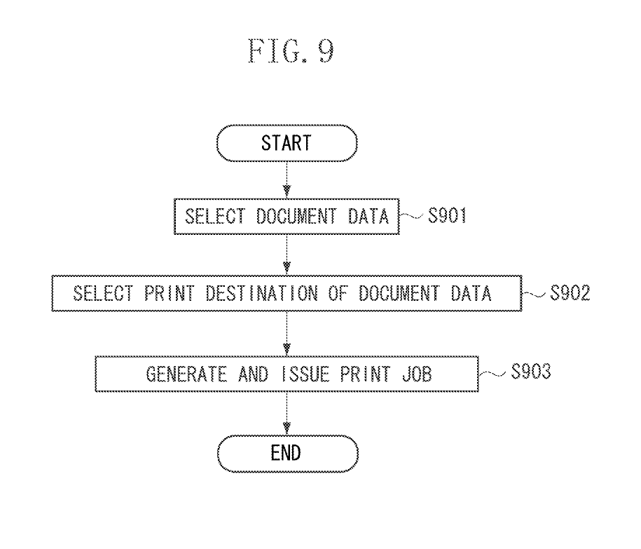

FIG. 9 is a flowchart illustrating an example of print job issuance processing at the terminal apparatus 101.

In step S901, the user selects document data to be printed from document data stored in the document data management unit 501. The user specifies the document data by an input device such as a keyboard, a mouse, or a touch panel (not illustrated).

In step S902, the user selects a print destination of the document data selected in step S901. For example, the user can designate a print output destination by using an identifier of the print processing apparatus 102 or a user identifier. In the case of designating the print output destination by using the user identifier, a print job is issued to the print processing apparatus 102 corresponding to the user.

In step S903, the terminal apparatus 101 generates data by setting the document data in a format of the print job, and instructs printing to the print processing apparatus 102.

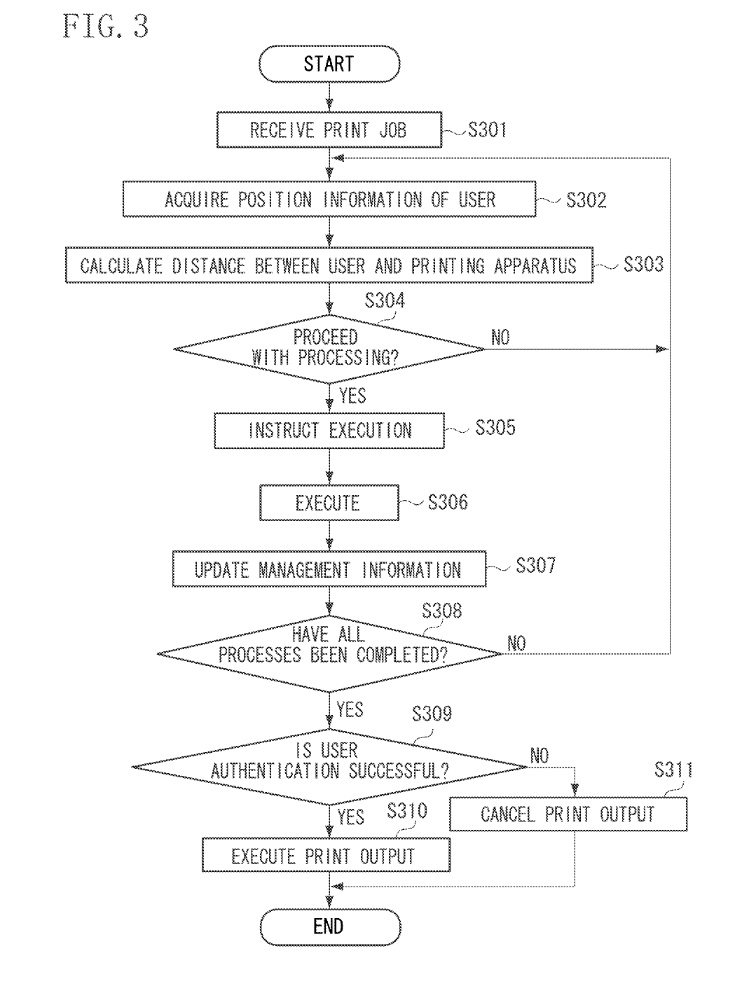

FIG. 3 is a flowchart illustrating an operation of the print processing apparatus 102.

In step S301, the network communication unit 701 receives a print job from the terminal apparatus 101. In step S302, the position information acquisition unit 704 acquires position information of the user who has issued the print job. In step S303, the determination unit 705 calculates a distance between the user and the print processing apparatus 102 based on the acquired position information and position information of the print processing apparatus 102. In step S304, the determination unit 705 determines whether to proceed with print processing by using the management information and the table stored in the storing unit 703 and the distance calculated in step S303. Specifically, the processing proceeds when processing having a smaller value of a distance to start processing described in the table than the distance calculated in step S303 is not included in current processing described in the management information.

For example, when “decompression processing” is described in the management information, and the distance calculated in step S303 is 450 meters, the processing proceeds up to external document data acquisition processing. When “decompression processing” is described in the management information, and the distance calculated in step S303 is 150 meters, the processing proceeds up to rendering processing.

When it is determined that the processing proceeds with the printing processing (YES in step S304), then in step S305, the determination unit 705 transmits an instruction to execute, among the processes described in the table, processing where the distance between the user and the print processing apparatus is equal to or less than a distance to start the processing to the printing control unit 801. In this case, the determination unit 705 transmits no instruction for processing already executed by using the management information. Specifically, when the distance between the user and the print processing apparatus is calculated to be 550 meters, and current processing is described to be “document data downloading processing” in the management information, the determination unit 705 instructs execution of decompression processing having a distance equal to or less than a distance to start the processing and yet to be executed. When it is determined that the processing does not proceed with the printing processing (NO in step S304), the processing of the print job stands by. Position information of the user is acquired again after a predetermined time (step S302), and a distance between the user and the print processing apparatus is calculated (step S303).

In step S306, based on the instruction from the determination unit, the printing control unit 801 controls the document data downloading unit 802, the decompression processing unit 803, the external document data acquisition unit 804, and the rendering processing unit 805. When a plurality of processes is executed, the printing control unit 801 controls the document data downloading unit 802, the decompression processing unit 803, the external document data acquisition unit 804, and the rendering processing unit 805 in this order.

In step S307, the determination unit 705 updates the management information stored in the storing unit 703 based on the instructed processing. In this case, the determination unit 705 can ask the printing control unit 801 whether the processing has been executed, and update the management information after it has received a notification of execution.

In step S308, the determination unit 705 determines whether all printing processes haven been executed. When not executed (NO in step S308), the processing returns to step S302. When executed (YES in step S308), then in step S309, the user authentication unit 706 authenticates the user based on user authentication information input by the user. When the user authentication is successful (YES in step S309), then in step S310, the print output unit 807 starts printing and outputting of the print job issued by the user to print and output it to a paper medium. When the user authentication is not successful at the user authentication unit 706 (NO in step S309), then in step S311, the print output unit 807 cancels the printing and outputting.

It should be noted that the series of processes at the document data downloading unit 802, the decompression processing unit 803, the external document data acquisition unit 804, and the rendering processing unit 805 enlarges a storage capacity necessary for the print data storage unit 806. The print processing apparatus 102 determines start timing of the plurality of printing processes based on its distance from the terminal apparatus 101. Thus, wasting of a storage area by processing of a print job of a user located far can be reduced.

According to the first exemplary embodiment, the print processing apparatus 102 proceeds with the predefined print processing based on the distance from the terminal apparatus 101 that has issued the print job. Thus, preprocessing such as downloading of the print job or verification of a data format of the print job is expected to be completed before the user having the terminal apparatus 101 arrives at the installation position of the print processing apparatus 102. As a result, when the user instructs a start of printing and outputting by inputting the authentication information, the printing and outputting can be started within a short waiting time.

According to the first embodiment, as described above, the printing processing is achieved by the four processes including the document data downloading processing, the decompression processing, the external document data acquisition processing, and the rendering processing. Not limited to this, however, the number of processes is preferably at least two. The present invention can be applied to processing including processes other than the document data downloading processing, the decompression processing, the external document data acquisition processing, and the rendering processing. However, it is desired to determine whether to proceed with the processing based on the distance when the necessary storage capacity becomes large after execution of next processing (step S303 illustrated in FIG. 3). When the necessary storage capacity does not become large, the processing can proceed without such determination.

Specific processing examples are preflight processing to insect matching of the data format of the print job, and data insertion processing when the print job uses insertion printing where data is inserted into a template to execute printing. Other examples are forming processing where the print processing apparatus 102 lines up data in the document data in an easy rendering order to achieve a high rendering speed of the document data, and data compression processing to remove unnecessary data included in the print job. Not limited to these, however, the present invention can be applied to calibration of the print processing apparatus 102, an operation checking test of the print processing apparatus 102, and processing executable before printing processing such as verification of digital signature data added to the print job.

In the first exemplary embodiment, when the print processing apparatus 102 can accurately understand the position of the terminal apparatus 101, the user authentication unit 706 can determine that authentication of a user who has come sufficiently close, for example, one meter or less, is successful without receiving any authentication information input from the user.

In the first exemplary embodiment, since the processing proceeds based on the distance between the terminal apparatus 101 and the print processing apparatus 102, a print job of a user highly likely to be requested for paper outputting can preferentially be processed. As a result, more memories or calculation resources are allocated to the print job of the user are highly likely to be requested for paper outputting, and printing and outputting can be executed by more efficiently using data of the print processing apparatus 101.

In the first exemplary embodiment, the terminal apparatus 101 issues the print job. However, another apparatus can also issue a print job. For example, a fixed and installed personal computer can issue a print job. In this case, the print job may include information regarding a terminal that acquires user position information, and the print processing apparatus 102 may acquire the user position information based on this information. Alternatively, the management server can manage the print job and the terminal that acquires the user position information, and notify the print processing apparatus 102 of information thereof.

In the first exemplary embodiment, when different users issue print jobs, processing first proceeds with the print job of the user sufficiently close to the print processing apparatus. Thus, when user authentication information is input to the print processing apparatus 102 to instruct a start of printing, the print processing apparatus 102 can start printing and outputting within a short waiting time.

Some of the processes of the print processing apparatus according to the first exemplary embodiment can be executed by other apparatuses.

In the first exemplary embodiment, the terminal apparatus 101 directly transmits the print job to the print processing apparatus 102. However, the print job can be transmitted via a print job management server. In the first exemplary embodiment, as described above, the print processing apparatus 102 directly acquires the position information of the user from the terminal apparatus 101. However, the print processing apparatus 102 can indirectly acquire the position information of the user from, for example, the management server. Specifically, the position information acquisition unit 503 of the terminal apparatus 101 periodically notifies the management server of the position information of the user. The print processing apparatus 102 then acquires the position information of the user from the management server to calculate a distance between the user and the print processing apparatus 102, and changes processes of the print job.

According to a first modified example of the first exemplary embodiment, a table taking a data size of a print job into consideration is used.

The first modified example provides the same functions as those illustrated in the block diagram of the print processing apparatus 102 according to the first exemplary embodiment except for the storing unit 703 and the determination unit 705. A table stored in the storing unit 703 is different from that of the first exemplary embodiment.

The storing unit 703 stores, in addition to the function of the first exemplary embodiment, a data size of a print job acquired via the network communication unit 701. FIG. 4C illustrates an example of a table stored in the storing unit 703. The table defines, for processes corresponding to the plurality of printing processes, conditions of starting the processes based on the distance between the user and the print processing apparatus and the data size of the print job. Processing 1, processing 2, processing 3, and processing 4 correspond to document data downloading processing, decompression processing, external document data acquisition processing, and rendering processing. The printing processes are executed in the order of the processing 1, the processing 2, the processing 3, and the processing 4. Long distances to start printing are allocated in the processing order and in a large order of data sizes.

The determination unit 705 instructs the print processing unit 702 to start processing based on the distance between the user who has issued the print job and the print processing unit 102 and the data size of the print job. Specifically, the determination unit 705 compares the distance between the user and the print processing unit 102 with a distance corresponding to the data size of the print job described in the table to instruct a start of processing.

FIG. 5 is a flowchart illustrating an operation of the print processing apparatus 102 according to the first modified example.

Steps except steps S601 and S602 are similar to those of the first exemplary embodiment, and thus description thereof is omitted. In step S601, the storing unit 703 acquires and stores a data size of a print job received in step S301. In step S602, the determination unit 705 instructs, by using the data size of the print job stored in the storing unit 703 and the table, a print processing unit 702 to start processing based on the distance between the user who has issued the print job and the print processing apparatus 102.

To describe an example by using the table illustrated in FIG. 4C, when a data size is 15 megabytes, and a distance is 900 meters, processes having distance values larger than 900 meters in a line of 10 megabytes or greater, namely, the processing 1, the processing 2, and the processing 3, are executed.

The first modified example has been described by using the data size. However, in place of the data size, the number of pages of document data can be used.

In the case of a print job for printing document data of a large data size, as compared with a print job for printing document data of a small data size, processing time is longer for downloading or rendering the print job. Thus, as a data size is larger, processing is started earlier, enabling completion of printing preparation when the user arrives at the print processing apparatus 102, or shortening of waiting of the user who has arrived.

According to a second modified example of the first exemplary embodiment, a table taking a moving speed of a user who has issued a print job data size of a print job into consideration is used. The second modified example provides the same functions as those illustrated in the block diagram of the print processing apparatus 102 according to the first exemplary embodiment except the position information acquisition unit 704 and the determination unit 705. A table stored in the storing unit 703 is different from that of the first exemplary embodiment.

The position information acquisition unit 704 acquires not only position information of the user but also a user's moving speed. For an acquisition method of the moving speed, a moving speed notified from the terminal apparatus 101 or a moving speed estimated from a moving method input by the user during issuance of the print job can be used. Alternatively, the storing unit 703 stores history of the position information of the user, and a moving speed can be estimated from a position and time included in history information.

FIG. 4D illustrates an example of a table stored in the storing unit 703. The table defines, for processes corresponding to a plurality of printing processes, conditions of starting the processes based on a distance between the user and a print processing apparatus and a user's moving speed. Processing 1, processing 2, processing 3, and processing 4 correspond to document data downloading processing, decompression processing, external document data acquisition processing, and rendering processing. The printing processes are executed in the order of the processing 1, the processing 2, the processing 3, and the processing 4. Long distances to start printing are allocated in the processing order and in the order of higher users' moving speeds.

The determination unit 705 instructs the print processing unit 702 to start processing based on the distance between the user who has issued the print job and the print processing unit 102 and the user's moving speed. Specifically, the determination unit 705 compares the distance between the user and the print processing unit 102 with a distance corresponding to the user's moving speed described in the table to instruct a start of processing.

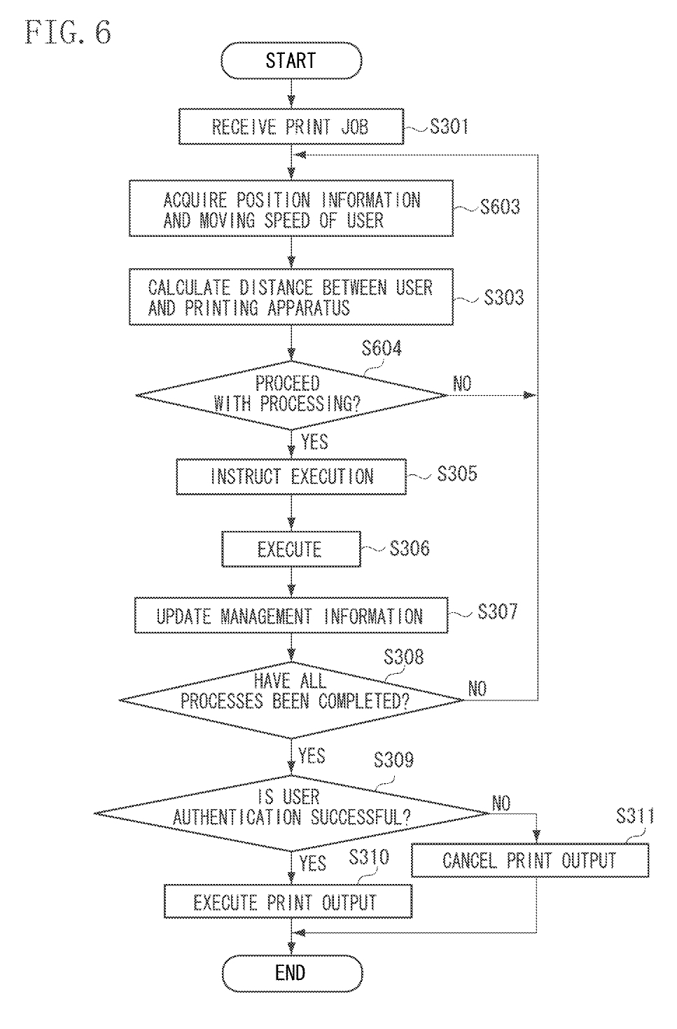

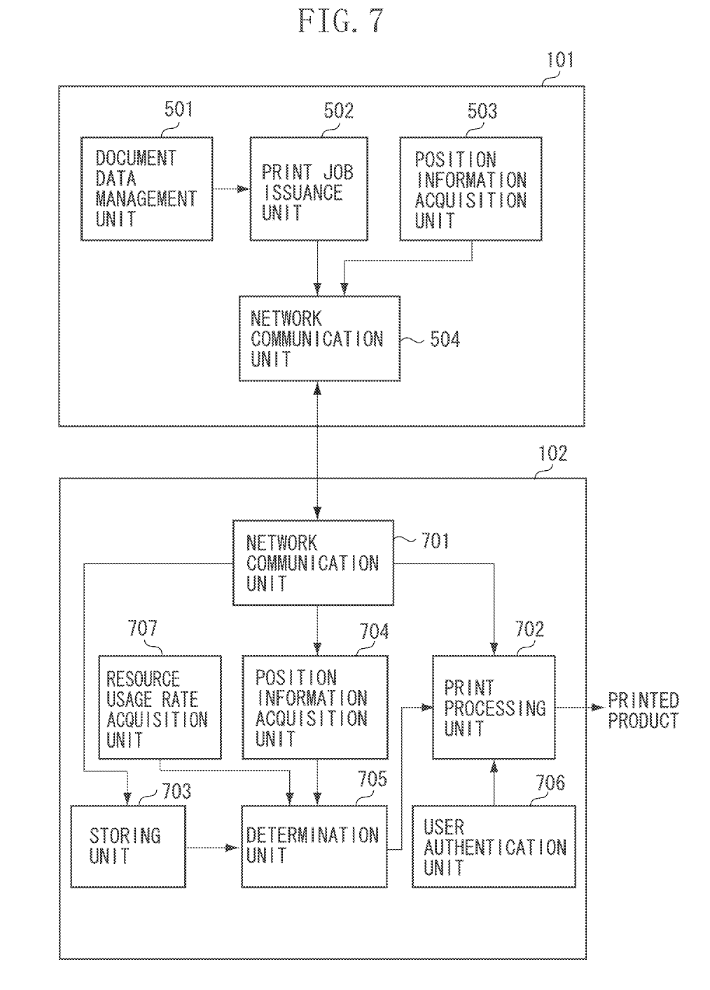

FIG. 6 is a flowchart illustrating an operation of the print processing apparatus 102 according to the second modified example.

Steps except steps S603 and S604 are similar to those of the first exemplary embodiment, and thus description thereof is omitted. In step S603, the position information acquisition unit 704 acquires position information and a moving speed of the user. In step S604, the print processing apparatus 102 instructs, by using the user's moving speed and the table, the print processing unit 702 to start processing based on the distance between the user who has issued the print job and the print processing apparatus 102.

To describe an example by using the table illustrated in FIG. 4D, when the user's moving speed is 6 km/hr and the distance is 1000 meters, processes having distance values larger than 1000 meters in a line of 4 km/hr to 10 km/hr, namely, the processing 1 and the processing 2, are executed.

There is a high possibility that a user moving to the print processing apparatus 102 by a transportation method of a high moving speed will arrive at the print processing apparatus earlier than a user moving slowly such as walking. Thus, as described above in the second modified example, for a job of the user moving fast, starting processing earlier enables completion of printing preparation when the user arrives at the print processing apparatus 102, or shortening of waiting of the user who has arrived.

The first exemplary embodiment has been directed to a case where the processing at the print processing apparatus 12 proceeds in one direction. However, according to a third modified example of the first exemplary embodiment, supposing a print processing apparatus of low resources and taking recourses of the print processing apparatus 102 into consideration, priority is decreased for a print job of a user who has not yet come to receive a printed product. For example, when the user returns halfway to the print processing apparatus 102 to receive the printed product, an unnecessary print job may be downloaded or rendered, thus wasting the resources of the print processing apparatus 102. The resources of the print processing apparatus 102 according to the third modified example are stored resources of the print data storage unit 806, calculation resources such as rendering, and communication resources of the network communication unit 701.

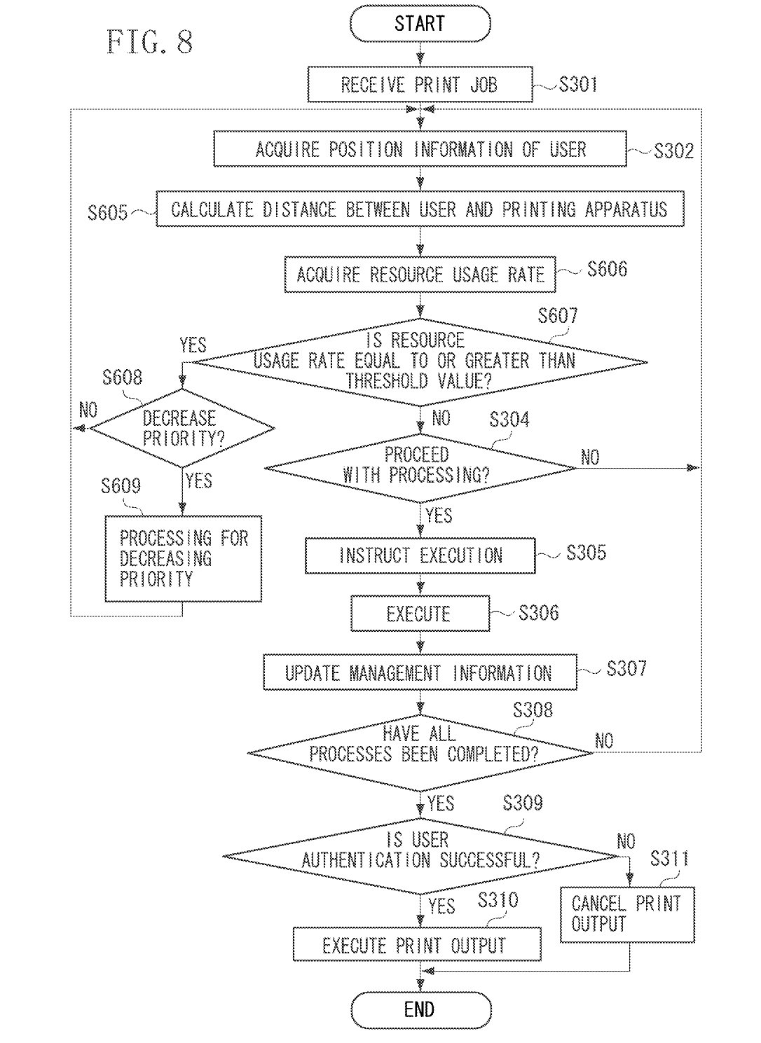

FIG. 7 is a functional block diagram illustrating the print processing apparatus 102 according to the third modified example.

The third modified example provides the same functions as those illustrated in the block diagram of the print processing apparatus 102 of the first exemplary embodiment except a storing unit 703, a determination unit 705, and a resource usage rate acquisition unit 707. A terminal apparatus 101 is similar to that of the first exemplary embodiment, and thus description thereof is omitted.

The storing unit 703 stores, in addition to the function described above in the first exemplary embodiment, history of a distance between the user and the print processing apparatus and a threshold value of a resource usage rate. For the history of the distance, time and a distance between the user and the print processing apparatus at the time are stored as history.

The resource usage rate acquisition unit 707 acquires a usage rate of the resources of the print processing apparatus 101 such as memory resources, calculation resources, or communication resources. Specifically, the resource usage rate acquisition unit 707 acquires the usage rate by measuring a usage rate of a memory of the print processing apparatus 102, a usage rate of CPU processing time, or a use amount of network traffic.

The determination unit 705 instructs, in addition to the function described above in the first exemplary embodiment, switching of processes based on the resource usage rate. The process switching is described below.

FIG. 8 is a flowchart illustrating an operation of the print processing apparatus 102 according to the third modified example. Steps except steps S605 to S609 are similar to those of the first exemplary embodiment, and thus description thereof is omitted.

In step S605, the determination unit 705 calculates a distance between the user and the print processing apparatus based on acquired position information and position information of the print processing apparatus 102, and stores the time and the calculated distance as history in the storing unit 703. In step S606, the resource usage rate acquisition unit 707 acquires a usage rate of the resources of the print processing apparatus 102 such as memory resources, calculation resources, or communication resources.

In step S607, the determination unit 705 compares the resource usage rate acquired in step S606 with the threshold value of the resource usage rate stored in the storing unit 703 to determine whether the resource usage rate is equal to or greater than the threshold value. The processing proceeds to step S304 and after when it is determined that the resource usage rate is not equal to or greater than the threshold value (NO in step S607). When it is determined that the resource usage rate is equal to or greater than the threshold value (YES in step S607), then in step S608, the determination unit 705 determines whether to decrease processing priority by using the distance history stored in the storing unit 703. In this case, when a change in distance is equal to or less than a predetermined value, namely, the user has not moved, and when a distance value is large, namely, the user has moved far from the print processing apparatus 102, by using the distance history, the determination unit 705 determines to decrease processing priority. When the user has not moved, it can be determined that the user has not moved to receive the printed product. When the user has moved far from the print processing apparatus 102, it can be determined that the user has not moved to receive the printed product.

In step S609, when it is determined that the processing priority is to be decreased, the determination unit 705 executes processing to decrease the priority. In the processing to decrease the priority, the processing is preferentially swapped from an expensive memory to an inexpensive hard disk, or data is compressed to reduce a storage capacity. Alternatively, print data (print data A) of a last process is stored in a storage medium, and print data (print data B) of a processing result of the current process is deleted to return to the last process (print data A) of the current process. In this case, when a difference in data size between the print data A and the print data B is smaller than the print data B, the print data A can be deleted. This can reduce a capacity of the storage medium. In the processing to decrease the priority, a method for simply deleting current print data to return a process of the print job stored in print information, thereby executing printing processing all over again, can be employed.

The preferential swapping from the expensive memory to a storage medium such as an inexpensive hard disk enables preferential processing of a print job of a user close to the print processing apparatus 102 in a high-speed memory. The processing to return to the last process of the current process among the processes corresponding to the plurality of printing processes is, according to the first exemplary embodiment, to return to the decompression processing that is a last process when the current process is external document data acquisition processing. By returning to the last process among the processes corresponding to the plurality of printing processes, a data amount stored in the print data storage unit 806 such as a memory can be expected to decrease. Deleting the external document data acquired by the external document data acquisition unit 804 in the first exemplary embodiment enables effective utilization of a storage area such as a memory.

In the third modified example, when the priority of the print job is decreased, the processing returns to the last process among the processes corresponding to the plurality of printing processes. However, the processing can be returned to a first before the last or a second before the last. In such a case, since the processing is returned to the previous process to be resumed, the calculation resources or the communication resources of the print processing apparatus 102 may be repeatedly consumed. Thus, the calculation resources can be saved more by determining which process to return to, and appropriately returning the processing. For example, the print processing apparatus 102 measures a calculation resource use amount, a communication resource use amount, and a memory resource use amount in each processing of the print job to store them in the storing unit 703. When the processing is returned to the previous process, consumed resources of the print job to be canceled because of the return to the previous process is set smaller than a permissible threshold value. This can reduce consumption of resources by resumption of the processing. According to the third modified example, even in the print processing apparatus 102 of low resources, printing of the print job can be efficiently processed. Particularly, the print job of the user expected to have moved to receive the printed product is preferentially processed. As a result, a user's waiting time at the print processing apparatus can be shortened.

The first exemplary embodiment has been directed to the case where the print processing apparatus 102 determines transition of the printing processes based on the distance between the terminal apparatus 101 and the print processing apparatus 102 to execute printing and outputting. However, a management server outside the print processing apparatus 102 can determine transition of the printing processes to control transition of the printing processes in the print processing apparatus 102. According to a second exemplary embodiment of the present invention, a print processing apparatus 102 is achieved with a simple configuration by determining process transition at the print processing apparatus 102 by a management server.

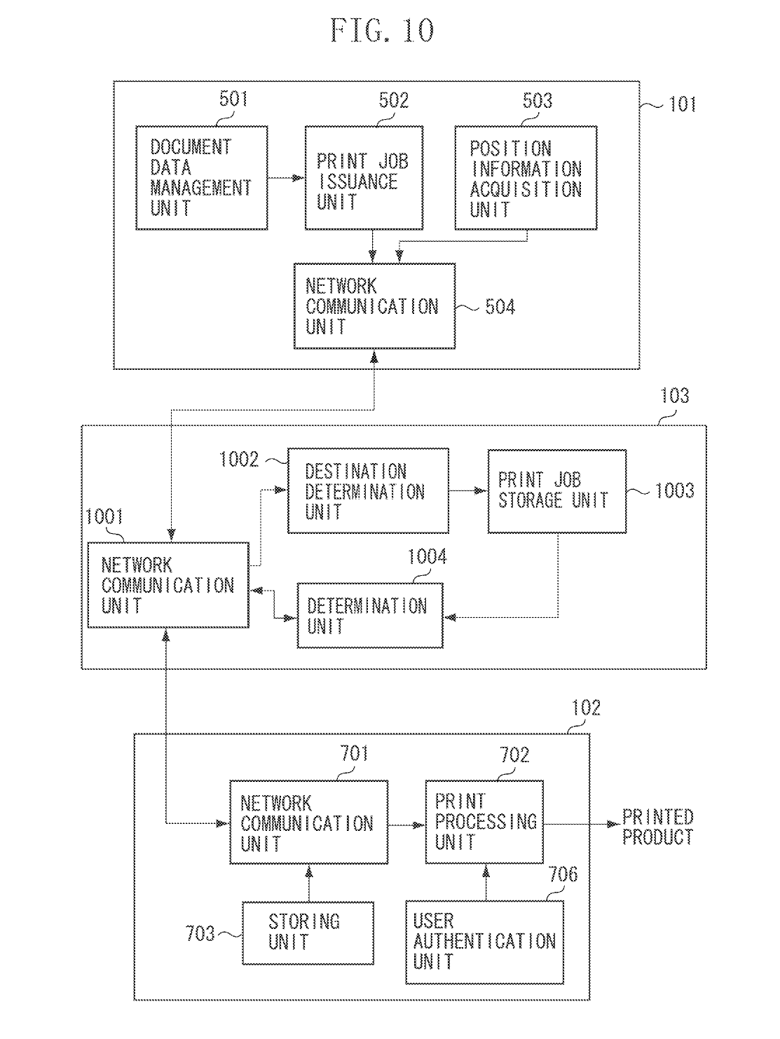

FIG. 10 illustrates an example of an outline of a system according to the second exemplary embodiment. In FIG. 10, a terminal apparatus 101, the print processing apparatus 102, and a management server 103 transfer data via a network. A configuration and a processing flow of the terminal apparatus 101 according to the second exemplary embodiment are similar to those of the first exemplary embodiment, and thus description thereof is omitted.

A configuration of the management server 103, which manages printing processing of a print job issued by a user, is described.

A network communication unit 1001 transmits print job data issued by the terminal apparatus 101 to a destination determination unit 1002, and position information of a user who has issued a print job and the print processing apparatus 102 to a determination unit 1004. The print job transmits determination instruction information of process transition of the print job at the determination unit 1004 to the print processing apparatus 102. The network communication unit 1001 controls communication processing of a wired LAN, a wireless LAN, or a portable wireless terminal to communicate data with the terminal apparatus 101 and the print processing apparatus 102.

The destination determination unit 1002 receives the print job data issued from the terminal apparatus 101, and solves pairing of a terminal apparatus 101 owned by a receiving user of the print job and the print processing apparatus 102 that prints and outputs the print job. The destination determination unit 1002 manages a correspondence table between an identifier of the destination user and an identifier of the terminal apparatus 101, and identifies the terminal apparatus 101 based on the identifier of the receiving user designated in the print job. When the identifier of the terminal apparatus 101 of the receiving user is designated for the print job, the terminal apparatus 101 of the identifier is set as a terminal of the receiving user. A print job storage unit 1003 manages the print job data received from the network communication unit 1001, the terminal apparatus 101 of the receiving user identified by the destination determination unit 1002, and the identifier of the print processing apparatus 102 that outputs the print job.

The determination unit 1004 stores the table information described above in the first exemplary embodiment, and determines process transition of the print job stored in the print job storage unit 1003. Specifically, the determination unit 1004 acquires position information from the terminal apparatus 101 and the print processing apparatus 102 designated for the print job. The determination unit 1004 calculates a distance between the apparatuses based on the position information, and determines process transition of the print job based on table transition conditions. After determination of process transition of the print job based on the distance between the apparatuses, the determination unit 1004 transmits determination instruction information of the process transition of the print job to the print processing apparatus 102. For the position information of the terminal apparatus 101 and the print processing apparatus 102, the management server can make inquiries to the terminals to acquire the position information (PULL type position information acquisition), or the position information can periodically be received from both terminals (PUSH type position information acquisition).

A configuration of the print processing apparatus 102 that prints and outputs the print job issued by the user is described.

A difference of the second exemplary embodiment from the first exemplary embodiment concerning the print processing apparatus 102 is that the process transition of the print job is determined in response to a process transition instruction received from the management server 103.

Thus, a print processing unit 702, a storing unit 703, and a user authentication unit 706 are similar in configuration and processing to those of the first exemplary embodiment, and description thereof is omitted.

A network communication unit 701 receives the print job data and the determination instruction information of the process transition of the print job from the management server 103 to transmit them to the print processing unit 702. The print processing unit 702 controls print job processing based on the determination instruction information. The network communication unit 701 receives position information of the print processing apparatus 102 from the storing unit 703 to transmit it to the management server 103.

According to the second exemplary embodiment, components of the print processing apparatus 102 can be omitted as compared with the first exemplary embodiment.

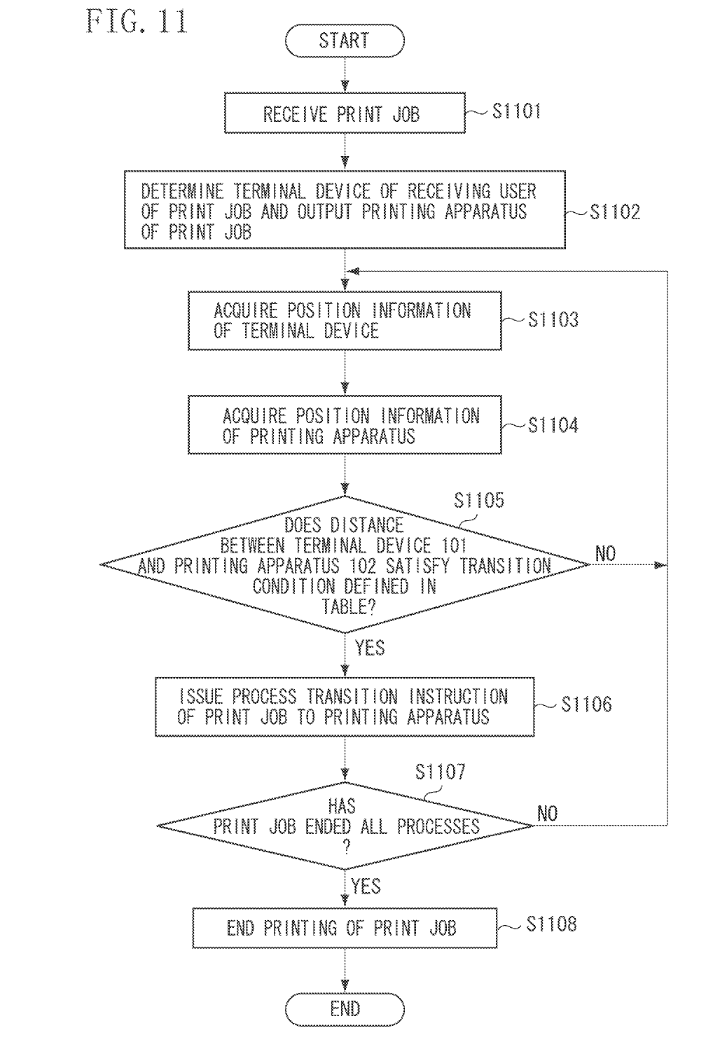

FIG. 11 is a flowchart illustrating an example of process transition processing of the print job in the management server 103.

In step S1101, the network communication unit 1001 receives print job data. In step S1102, the management server 103 determines a terminal apparatus 101 of a receiving user and a print processing apparatus 102 based on destination information of a print job. In step S1103, the network communication unit 1001 acquires position information of the terminal apparatus 101. In step S1104, the network communication unit 1001 acquires position information of the print processing apparatus 102. When a distance between the terminal apparatus 101 and the print processing apparatus 102 satisfies transition conditions defined in a process transition table (YES in step S1105), then in step S1106, the management server 103 issues a process transition instruction of the print job to the print processing apparatus 102. When the distance between the terminal apparatus 101 and the print processing apparatus 102 does not satisfy transition conditions defined in a process transition table (NO in step S1105), the management server 103 repeats steps S1103 and S1104 again after a fixed period.

When all printing processes have ended for the print job (YES in step S1107), the management server 103 ends the printing processing of the print job, and deletes the print job from the print job storage unit 1003. When there are still printing processes to be executed, the management server 103 repeats steps S1103 to S1106.

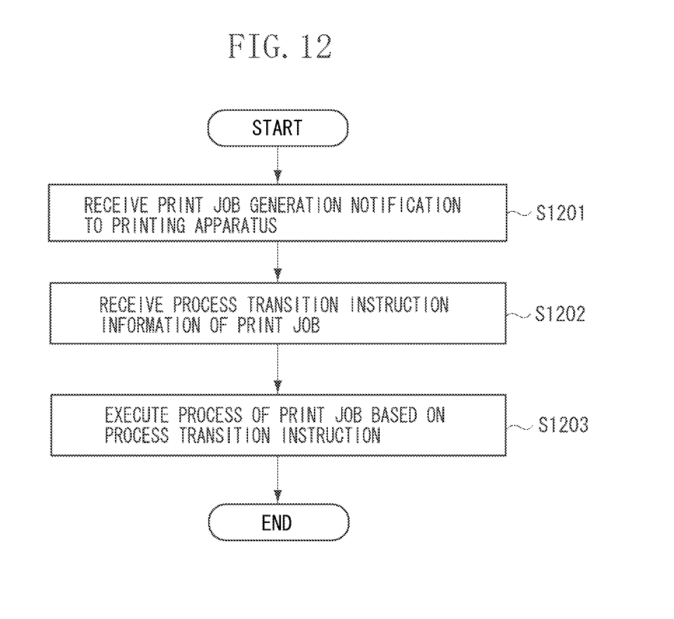

FIG. 12 is a flowchart illustrating an example of printing processing of the print job in the print processing apparatus 102.

In step S1201, the network communication unit 701 of the print processing apparatus 102 receives generation of a print job issued to the print processing apparatus 102.

In step S1202, the print processing apparatus 102 receives a process transition instruction of the print job from the management server 103. In step S1203, the print processing apparatus 102 executes the processing. The print processing apparatus 102 prints and outputs the print job by repeating steps S1202 and S1203 when necessary.

The processing flow from the issuance of the print job to the printing and outputting according to the second exemplary embodiment has been described. According to the second exemplary embodiment, acquiring the position information of the terminal apparatus 101 and the print processing apparatus 102 and determining the process transition of the print job by the management server outside the print processing apparatus enable a simple configuration of the print processing apparatus 102.

Thus, according to the above-described exemplary embodiments, for printing and outputting of the print job issued via the network, the print job can be printed and output at user's arrival timing at the image processing apparatus.

Aspects of the present invention can also be realized by a computer of a system or apparatus (or devices such as a CPU, an MPU, and/or the like) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., a computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2011-036022 filed Feb. 22, 2011 and No. 2012-013038 filed Jan. 25, 2012, which are hereby incorporated by reference herein in their entirety.

What is claimed is:

1. A print processing apparatus comprising:
a plurality of processing units configured to deal with a plurality of printing processes;
a storing unit configured to store a table in which processing start conditions in the plurality of printing processes are defined based on a distance between a user and the print processing apparatus;
an acquisition unit configured to acquire a distance between a position of the user who has issued a print job and the print processing apparatus; and
a control unit configured to control the plurality of processing units for the print job based on the table and the acquired distance.

2. The print processing apparatus according to claim 1, wherein in the plurality of processing units, a storage capacity necessary for storing a processing result becomes larger each time the plurality of processing units proceeds with processing.

3. The print processing apparatus according to claim 1, wherein the plurality of processing units deals with least two of document data downloading processing, decompression processing, external document data acquisition processing, and rendering processing.

4. The print processing apparatus according to claim 1, further comprising:
an authentication unit configured to authenticate the user; and
an output unit configured to print and output the print job processed by the plurality of processing units when authentication executed by the authentication unit is successful.

5. The print processing apparatus according to claim 1, further comprising an acquisition unit configured to acquire a usage rate of resources of the print processing apparatus,
wherein the control unit controls the plurality of processing units based on the acquired usage rate of the resources, the table, and the distance.

6. The print processing apparatus according to claim 1, wherein in the table, the processing start conditions in the plurality of printing processes are defined based on a data size of the print job and the distance between the user and the print processing apparatus.

7. The print processing apparatus according to claim 1, wherein in the table, the processing start conditions in the plurality of printing processes are defined based on a user's moving speed and the distance between the user and the print processing apparatus.

8. A method for controlling a print processing apparatus, the method comprising:
acquiring a distance between a position of a user who has issued a print job and the print processing apparatus; and
executing a plurality of processes corresponding to a plurality of printing processes for the print job based on the acquired distance and a table in which processing start conditions in the plurality of printing processes are defined based on a distance between the user and the print processing apparatus.

9. The method according to claim 8, wherein in the plurality of processes, a storage capacity for storing a processing result becomes large reach time processing proceeds.

10. The method according to claim 8, wherein the plurality of processes deals with at least two of document data downloading processing, decompression processing, external document data acquisition processing, and rendering processing.

11. The method according to claim 8, further comprising:
authenticating the user; and
printing and outputting the print job processed by the plurality of processes when authentication is successful.

12. The method according to claim 8, further comprising:
acquiring a usage rate of resources of the print processing apparatus; and
executing the plurality of processes based on the acquired usage rate of the resources, the table, and the distance.

13. The method according to claim 8, wherein in the table, the processing start conditions in the plurality of printing processes are defined based on a data size of the print job and the distance between the user and the print processing apparatus.

14. The method according to claim 8, wherein in the table, the processing start conditions in the plurality of printing processes are defined based on a user's moving speed and the distance between the user and the print processing apparatus.

15. A computer-readable storage medium storing a program which is read out and executed by a computer so as to cause the computer to function as units of the print processing apparatus according to claim 1.
